(19) United States
(12) Patent Application Publication
(10) Pub. No.: US 2022/0322868 A1
(43) Pub. Date: Oct. 13, 2022

(54) INTEGRATED METHOD TO BREW, CHILL, HEAT, AND FILTER

(71) Applicant: Central Ave Holdings, LLC, Watertown, MA (US)

(72) Inventor: David DUSSAULT, Stoneham, MA (US)

(21) Appl. No.: 17/809,176

(22) Filed: Jun. 27, 2022

Related U.S. Application Data
(63) Continuation of application No. PCT/US2021/012234, filed on Jan. 6, 2021.
(60) Provisional application No. 62/958,508, filed on Jan. 8, 2020.

(51) Int. Cl. A47J 31/54; A47J 31/46; A47J 31/00

(52) U.S. Cl. CPC A47J 31/542; A47J 31/462; A47J 31/468; A47J 31/002

(57) ABSTRACT

An apparatus may comprise a heater, a brewer, a chiller, and a heat exchanger. The heater may be configured to heat water to produce heated water. The brewer may be configured to brew a beverage using the heated water. The chiller may be configured to chill the beverage to produce a chilled beverage. The heat exchanger may have a first fluid flow path and a second fluid flow path in thermal communication with the first fluid flow path. An input to the first fluid flow path may be configured to receive source water and an output of the first fluid flow path may be configured to provide the water to the heater. An input to the second fluid flow path may be configured to receive the beverage from the brewer and an output of the second fluid flow path may be configured to provide the beverage to the chiller.

### CROSS-REFERENCE TO RELATED APPLICATIONS

This application claims priority to U.S. Provisional Application No. 62/958,508, entitled INTEGRATED METHOD TO BREW, CHILL, HEAT, AND FILTER, filed Jan. 8, 2020, the contents of which are incorporated herein by reference, in their entirety, for all purposes.

### BACKGROUND

U.S. Patent Application Publication No. 2018/0344074 (“the '074 Publication”), owned by the same Assignee as the present application, describes systems and techniques for producing fresh, flash-chilled coffee without the compromises associated with traditional methods like brew over ice and cold brew. The cold coffee production systems and techniques of the type the '074 Publication describes are referred to herein as “Snapchill.”

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, an apparatus comprises a heater, a brewer, a chiller, and a heat exchanger. The heater is configured to heat water to produce heated water. The brewer is configured to brew a beverage using the heated water. The chiller is configured to chill the beverage to produce a chilled beverage. The heat exchanger has a first fluid flow path and a second fluid flow path in thermal communication with the first fluid flow path. An input to the first fluid flow path is configured to receive source water and an output of the first fluid flow path is configured to provide the water to the heater. An input to the second fluid flow path is configured to receive the beverage from the brewer and an output of the second fluid flow path is configured to provide the beverage to the chiller.

In some disclosed embodiments, a method involves heating water with a heater to produce heated water, brewing a beverage with a brewer using the heated water, chilling the beverage with a chiller to produce a chilled beverage, receiving source water at an input to a first fluid flow path of a heat exchanger and providing the water to the heater via an output of the first fluid flow path, the first fluid flow path being in thermal communication with a second fluid flow path of the heat exchanger, and receiving the beverage at an input to the second fluid flow path and providing the beverage to the chiller via an output of the second fluid flow path.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1 shows a first example flow diagram of a heat recovery concept integrating brewing and chilling;

FIG. 2 shows a second example flow diagram of a heat recovery concept integrating brewing and chilling;

FIG. 3 shows a third example flow diagram of a heat recovery concept integrating brewing and chilling;

FIG. 4 shows a fourth example flow diagram of a heat recovery concept integrating brewing and chilling;

FIG. 5 shows a fifth example flow diagram of a heat recovery concept integrating brewing and chilling;

FIG. 6A shows an example batch chill process for transferring heat from coffee to refrigerant in an evaporator;

FIG. 6B shows an example continuous chill process for transferring heat from coffee to refrigerant in an evaporator;

FIG. 7A shows a first example configuration of the continuous flow heat exchanger shown in FIG. 6B;

FIG. 7B shows a second example configuration of the continuous flow heat exchanger shown in FIG. 6B;

FIG. 7C shows a third example configuration of the continuous flow heat exchanger shown in FIG. 6B;

FIG. 7D shows a fourth example configuration of the continuous flow heat exchanger shown in FIG. 6B;

FIG. 7E shows a fifth example configuration of the continuous flow heat exchanger shown in FIG. 6B;

FIG. 7F shows a sixth example configuration of the continuous flow heat exchanger shown in FIG. 6B;

FIG. 8A shows a first example brewing method that may be employed by the brewer shown in FIGS. 1-5;

FIG. 8B shows a second example brewing method that may be employed by the brewer shown in FIGS. 1-5;

FIG. 8C shows a third example brewing method that may be employed by the brewer shown in FIGS. 1-5; and

FIG. 9 shows the relative chill volume as a function of counterflow effectiveness for three source water temperatures.

### DETAILED DESCRIPTION

The market for iced coffee is substantial and growing. By brewing hot and rapidly chilling without ice, the Snapchill method may produce fresh coffee without the compromises associated with traditional methods like brew over ice and cold brew. Moreover, the freshness may survive in ready-to-drink (RTD) applications, such as when the flash-chilled coffee is bottled or canned for subsequent consumption. The '074 Publication, incorporated by reference above, describes systems and techniques for flash-chilling hot coffee on demand. This application describes methods for combining this chilling technology with brewing and/or filtering in order to increase throughput, improve quality, and/or decrease cost in a production environment.

There are many products and methods used to make chilled coffee at home and in cafes. Such products/methods generally fall into one of the following categories: slow chill, brew over ice, cold brew, and Snapchill. As a slow chill example, a pot of hot, fresh coffee may be put in the refrigerator to produce chilled coffee hours later. The problem here is time and oxidation, resulting in an unfortunate beverage void of freshness. For brew over ice, fresh coffee may be brewed concentrated, and poured over ice for a rapid chill. Here, the concentrated coffee has a compromised coffee extraction, and the total dissolved solids (TDS) changes as the ice melts, resulting in a taste experience ranging from overly concentrated to watery. Cold brew is currently the most popular approach. Here, the cold brewing temperature doesn't produce the same volatile aromatics as hot coffee, and the slow nature of the process introduces oxidation. With the Snapchill process, coffee may be brewed hot at the proper extraction, and then chilled rapidly without ice, resulting in a fresh iced coffee without compromise.

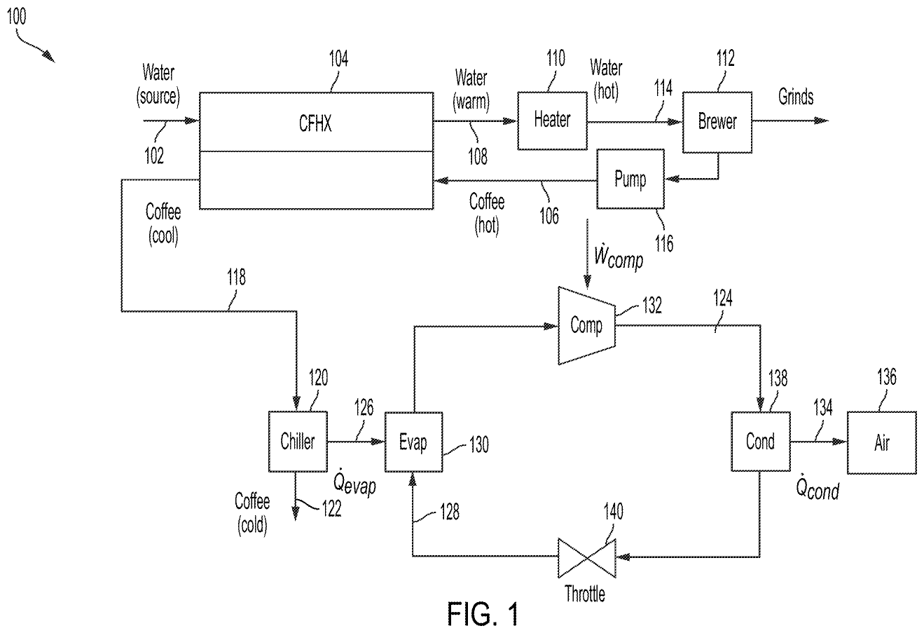

Salient features of the chilling technology described in the '074 Publication include a batch chilling process, coffee in direct contact with an evaporator coil, agitation, brew/chill timing, and a compressor based heat pump to reject the heat. FIGS. 1-5 (described in detail below) are flow diagrams illustrating how, in accordance with some implementations of the present disclosure, the approaches described in the '074 Publication may be expanded to integrate the chilling with the brewing and/or filtering, resulting in increased throughput, improved quality, and/or decreased cost.

Heat Recovery

FIG. 1 shows an example flow diagram 100 of a heat recovery concept integrating brewing and chilling. As shown, cool source water 102 (e.g., filtered tap water) may enter a counterflow heat exchanger (CFHX or counterflow) 104, and may be pre-heated by hot coffee 106 to produce warm water 108. The pre-heated, warm water 108 may then enter a heater 110 (shown separate from a brewer 112). The heater 110 may further heat the water to produce hot water 114 which may then be used by the brewer 112 to brew coffee. A fraction of the hot water 114 (roughly 10%) may be absorbed by the coffee grinds. Brewed coffee 106 may pass through the CFHX 104, and may be pre-chilled by the cool source water 102 to produce cool coffee 118. As illustrated, in some implementations, a pump 116 may be used to overcome the pressure drop in the CFHX 104 (e.g., if gravity head is insufficient). The cool coffee 118 may then pass to a chiller 120 that further chills the cool coffee 118 to produce cold coffee 122.

In some implementations, the chiller 120 may use a refrigeration cycle 124. For example, as shown in FIG. 1, in some implementations, heat 126 may be transferred from the cool coffee 118 to refrigerant 128 in an evaporator 130. A compressor 132 may raise the refrigerant pressure and saturation temperature. Heat 134 may be rejected to the room via forced air 136 at a condenser 138. A throttle process 140 may lower the refrigerant pressure and saturation temperature, returning to the evaporator 130 and completing the refrigeration cycle 124.

By pre-heating the water 102, the cycle time and power consumption of the brewer 112 may be reduced. By pre-chilling the coffee 106, the throughput of the chiller 120 may be increased. Depending on the counterflow effectiveness (defined as fraction of heat recovered), in some implementations, the power consumption to brew and chill (heater 110 and compressor 132) may be less than that of brewing alone (heater 110).

The heat pump component selection may depend on scale. Consider comparisons to HVAC applications. For chilling a cup of coffee, the thermal requirements may be similar to cooling a room with a window air conditioner, which may use a rotary compressor, a forced air tube/fin condenser, and a capillary tube. For chilling a keg of coffee, the thermal requirements may be similar to cooling a house with a central air conditioner, which may use a rotary or scroll compressor, a similar condenser, and thermal expansion valve. For larger barrels, the thermal requirements may be similar to cooling a building, which may use a centrifugal compressor and a large condenser, or a refrigeration chiller in combination with a cooling tower.

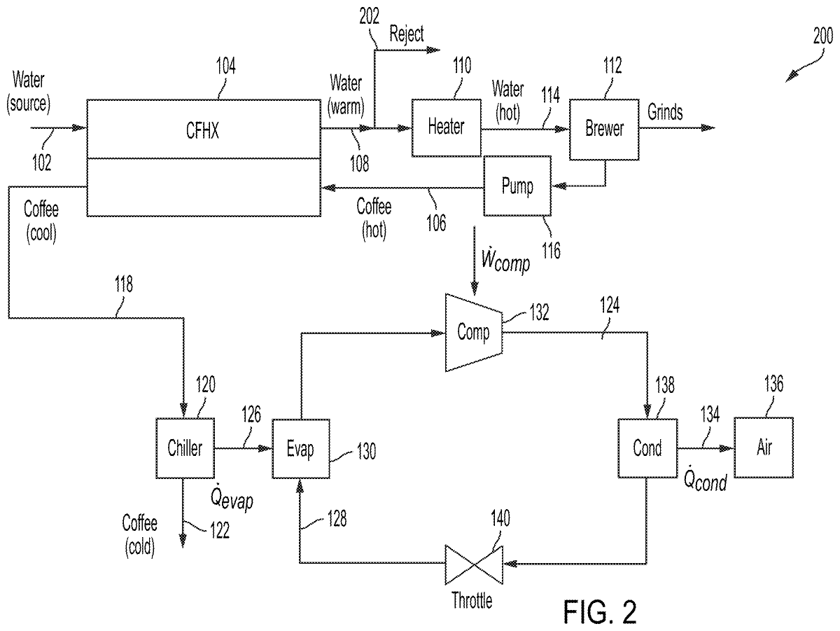

FIG. 2 shows an example flow diagram 200 that is similar to the flow diagram 100 shown in FIG. 1 and further illustrates how a water reject line 202 may be introduced between the CFHX 104 and the heater 110 in some implementations. The removal of excess warm water 108 via the water reject line 202 may boost the counterflow effectiveness relative to the coffee, pre-chilling the hot coffee 106 farther. This may be a consideration, for example, if the benefit of the increased throughput of the chiller 120 outweighs the cost of the rejected water.

Balanced Flow Control

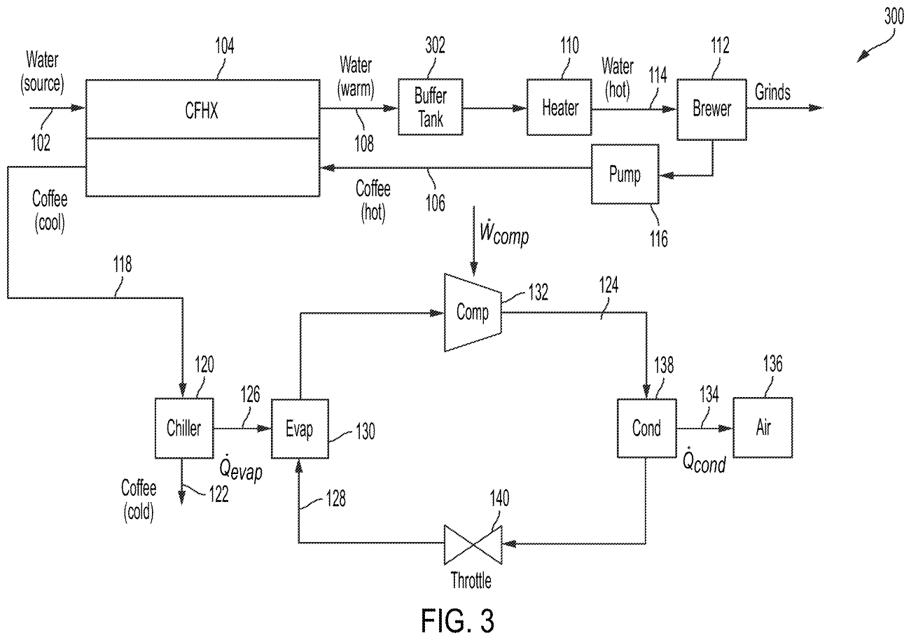

The counterflow effectiveness may be sensitive to the profile of the water and coffee flowrates as a function of time. The coffee flow may be relatively steady. The water flow (for commercial brewers) may be periodic (on, off, on, off, etc.). In the limit of one quick water flow, the effectiveness would be reduced to zero, regardless of surface area. FIG. 3 shows an example technique for balancing the water and coffee flows. In particular, FIG. 3 shows an example flow diagram 300 that is similar to the flow diagram 100 shown in FIG. 1 and further illustrates how a buffer tank 302 may additionally or alternatively be used to make the water flowrate independent of the flowrate to the brewer 112. By using the buffer tank 302 the water flowrate through the CFHX 104 may match the coffee side, and the flowrate to the heater 110 may be periodic.

Secondary Filter

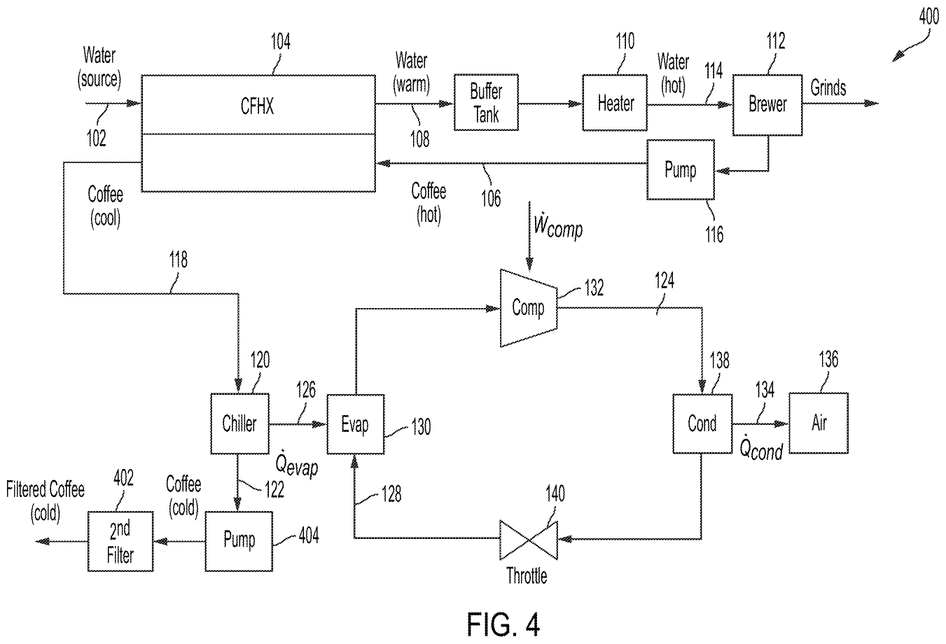

FIG. 4 shows an example flow diagram 400 that is similar to the flow diagram 100 shown in FIG. 1 and further illustrates how a secondary coffee filter 402 may be employed downstream of the chiller 120 in some implementations. As shown, in some implementation, a pump 404 may be used to feed the cold coffee 122 through the secondary filter 402. Paper coffee filters may allow suspended coffee solids to pass through that are under about ten to fifteen microns. The suspended solids may affect flavor in RTD applications because they continue to extract slowly over time. In some implementations, the secondary filter 402 may remove the suspended solids above about one micron, which may stabilize the flavor of the RTD beverage over time and improve clarity (a coffee scoring attribute).

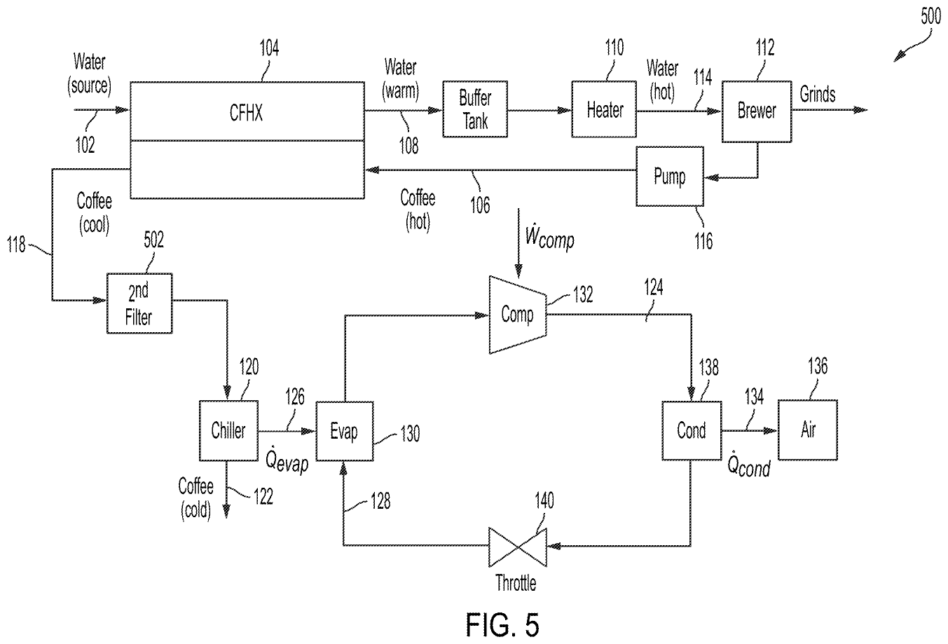

FIG. 5 shows an example flow diagram 500 that is similar to the flow diagram 100 shown in FIG. 1 and further illustrates how a secondary coffee filter 502 may additionally or alternatively be positioned between the CFHX 104 and the chiller 120. A benefit to such an implementation may be the ability to filter inline with a single pump, thus reducing labor. By contrast, in the configuration shown in FIG. 4, an operator may need to drain the coffee 122 from the chiller 120, and then use the pump 404 to feed it through the secondary filter 402—an additional manufacturing operation.

It should be appreciated that, in various embodiments, any of the additional features discussed above in connection with FIGS. 2-5 (e.g., the water reject line 202 shown in FIG. 2, the buffer tank 302 shown in FIG. 3, the secondary coffee filter 402 shown in FIG. 4, and/or the secondary coffee filter 502 shown in FIG. 5) may be employed in combination with the any of the other additional features described in connection with those figures.

Batch Vs Continuous Chill

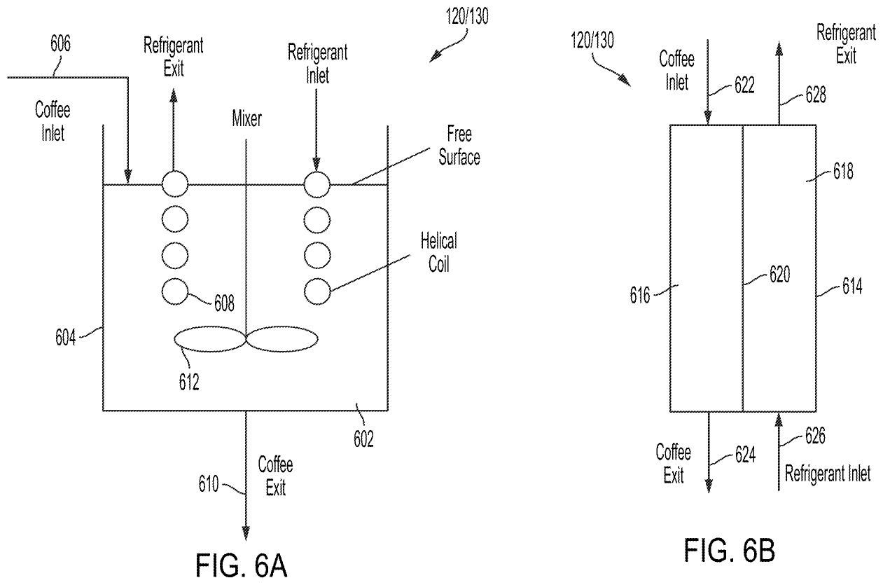

FIGS. 6A and 6B show examples how the heat 126 may be transferred from coffee in the chiller 120 to refrigerant in the evaporator 130, as illustrated in FIGS. 1-5. In particular, FIG. 6A shows a cross-sectional view of an example implementation for a batch chill process, and FIG. 6B shows an example implementation of a continuous chill process.

As shown in FIG. 6A, in a batch chill process, the entire volume of a batch 602 of coffee brewed by the brewer (shown in FIGS. 1-5) may be introduced into a cooling vessel or chamber 604 via a coffee inlet 606, and may be retained in the cooling chamber and chilled via a helical coil 608 of the evaporator 130 during a cooling interval. Following the cooling interval, the batch 602 of chilled coffee may be drained via a coffee outlet 610. In some implementations, the chilling process may start before the entirety of the batch 602 of coffee has been introduced into the cooling vessel/chamber 604, to reduce cycle time. As shown in FIG. 6A, in some implementations, a mixer 612 may be included within the cooling vessel/chamber 604 helical coil so as to be immersed within the batch 602 of coffee during the cooling interval. The mixer 612 may prevent ice formation on the coil 608, enhance heat transfer, and/or create a uniform coffee temperature field.

As shown in FIG. 6B, in a continuous process, a continuous flow heat exchanger 614 may be employed. As shown, in some implementations, the continuous flow heat exchanger 614 may include a first flow path 616 and a second flow path 618 that are separated by a common surface 620 through which the heat 126 (shown in FIGS. 1-5) may be transferred from coffee in the first flow path 616 to refrigerant in the second flow path 618. More specifically, the coffee may be introduced into the first flow path 616 at a coffee inlet 622 and may exit the first flow path 616 at a coffee exit 624. Similarly, the refrigerant may be introduced into the second flow path 618 at a refrigerant inlet 626 and may exit the second flow path 618 at a refrigerant exit 628. In some implementation, the continuous flow heat exchanger 614 may be configured such that the first flow path 616 only holds a fraction of the total volume of coffee being brewed by the brewer 112 (shown in FIGS. 1-5). The continuous flow process has the benefit of continuous operation but may introduce controls and cleaning complexities. A counterflow of coffee and refrigerant (as illustrated) may be preferable, because the refrigerant will evaporate and then enter the superheat phase, but it is not strictly required because the refrigerant temperature may be uniform in the saturation phase.

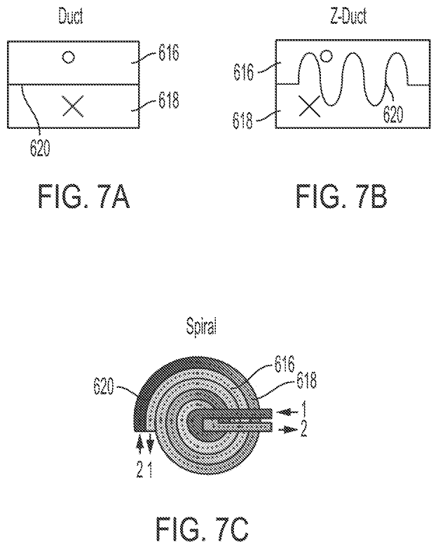

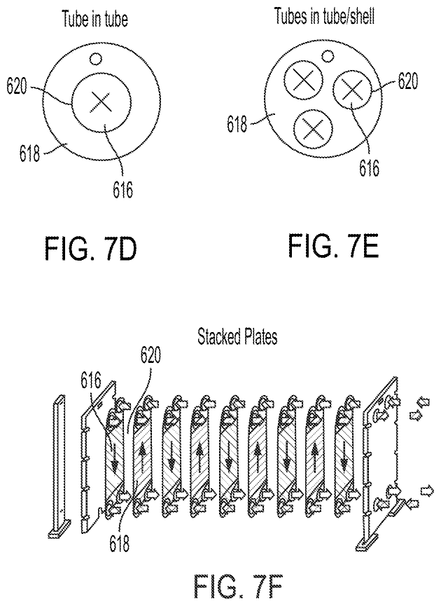

FIGS. 7A-F show example configurations of the continuous flow heat exchanger 614 shown in FIG. 6B. FIG. 7A illustrates a simple duct configuration in which the first flow path 616 may be separated from the second flow path 618 by a substantially planar common surface 620. FIG. 7B illustrates a Z-duct configuration in which the first flow path 616 may be separated from the second flow path 618 by common surface 620 shaped as a corrugated wall. FIG. 7C illustrates a spiral configuration in which the first flow path 616 may be separated from the second flow path 618 by common surface 620 having a spiral configuration. FIG. 7D illustrates a tube in tube configuration in which the first flow path 616 may be separated from the second flow path 618 by common surface 620 formed by the innermost tube. The tubes may for example have a helical shape. FIG. 7E illustrates a configuration in which multiple tubes are included within a shell, with the first flow path 616 being separated from the second flow path 618 by multiple common surfaces 620 formed by the innermost tubes. Finally, FIG. 7F illustrates an implementation in which the first flow path 616 and the second flow path 618 are formed by interleaved, stacked plates, with multiple common surfaces 620 being formed at the junction points of the respective plates. In each of FIGS. 7A, 7B, 7D and 7E, the dot represents flow in one direction and the cross represents flow in the opposite direction.

Batch Vs Continuous Brew

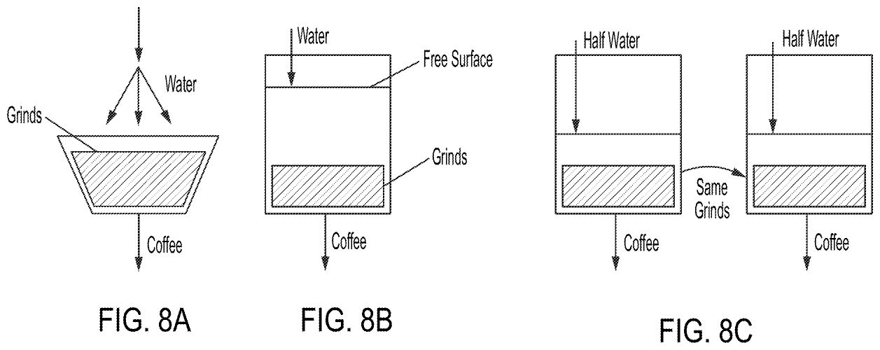

FIGS. 8A-C show three basic brewing methods. In particular, FIG. 8A shows a drip brewer, such as typical coffee machine or manual pour over—a continuous process; FIG. 8B shows immersion brewing, such as a French press—a batch process; and FIG. 8C shows a multi-stage immersion process, where the same grinds are used for multiple fresh water batches. Two stages are shown for simplicity.

From a thermal system point of view, the continuous vs. batch process may change the hot coffee flowrate as a function of time. For the continuous process (FIG. 8A), the flow may be steady and start basically immediately, so the chiller 120 can operate simultaneously with the brewer 112, minimizing the hot time duration of each coffee fluid particle. For the batch process (FIG. 8B), the hot coffee 106 flowrate generally doesn't start until the brewer 112 is finished, delaying the start time of the chiller 120 and therefore the cycle time. The multi-stage immersion methods (FIG. 8C) may provide a compromise between the two limits. As production scales up, a large batch method may provide economies of scale that make it a consideration, provided brew quality can remain high.

Bypass water is an option for quality drip brewing, especially at larger scales, where coffee 106 may be brewed slightly concentrated and then mixed with water. Typically 10-20% bypass water is used as direct hot water added to brew pot. For making Snapchilled coffee, the cold source water 102 may be used and added to the hot coffee line either upstream or downstream of the counterflow 104. In some implementations, a bypass water feedline may be connected between the a supply line for the source water 102 and the hot coffee line (either upstream or downstream of the heat exchanger 104) so as to allow the introduction of bypass water into the hot coffee 106 or the cool coffee 118. Adding the bypass water downstream of the counterflow 104 may be preferable thermally. Adding the bypass water upstream of the counterflow 104 may have the advantage of purging the coffee lines.

Throughput Calculations

The heat transfer in the chiller 120 may be given by

$${\dot{Q}}_{e v a p} = {ρ Vc}_{p} \frac{d T}{d t}$$

where ρ is density, V is volume of coffee, cₚ is specific heat, T is temperature and t is time. Consider two counterflow effectiveness scenarios, denoted a and b. For scaling simplicity, let the heat transfer rate be constant

$$1 ∼ ( \frac{{V}_{a}}{{V}_{b}} ) \frac{( \frac{{T}_{1 a} - {T}_{final}}{{t}_{chill , a}} )}{( \frac{{T}_{1 b} - {T}_{final}}{{t}_{chill , b}} )} \text{=>} ( \frac{{V}_{b}}{{V}_{a}} ) ∼ ( \frac{{T}_{1 a} - {T}_{final}}{{T}_{1 b} - {T}_{final}} ) ( \frac{{t}_{chill , b}}{{t}_{chill , a}} )$$

where T₁ is the starting temperature of the coffee, which is related to effectiveness ∈ by T₁ₐ=T_{brew}−∈ₐ(T_{brew}−T_{water}).

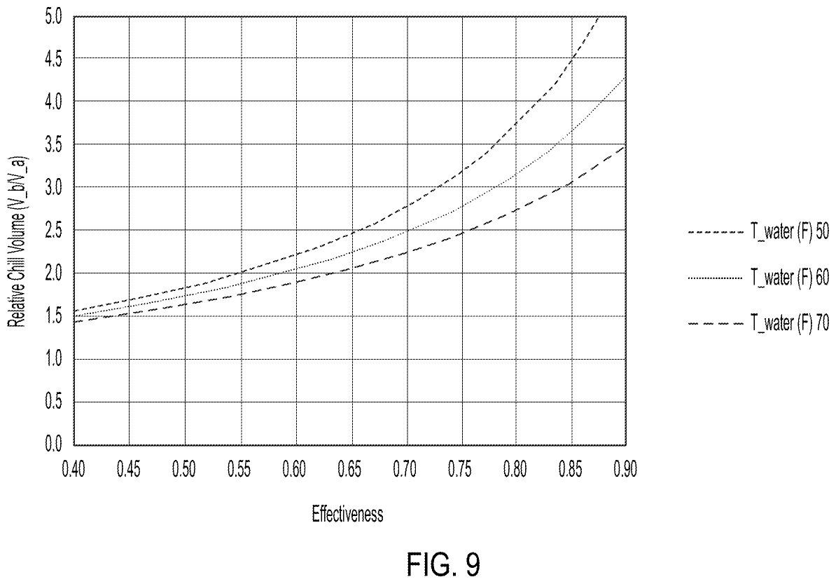

As effectiveness changes from “0” to “1,” the starting temperature in the chiller 120 may change from that of the hot brew 106 to that of the source water 102. To further constrain the scaling, let the chill time be the same between the two scenarios. FIG. 9 shows the relative chill volume as a function of effectiveness for three source water temperatures. As FIG. 9 illustrates, as the source water temperature decreases, the coffee 106 may be pre-chilled more, and the relative volume may increase. Similarly as the effectiveness increases, the relative volume may increase. At a source water temperature of 60 degrees, relative volumes of “2”, “3”, and “4” correspond to effectiveness values of “0.60”, “0.78”, and “0.88”, respectively. The practical implication is that a relative volume of “2” is achievable with simple flow controls, a relative volume of “3” is achievable with flow balancing, and a relative volume of “4” is achievable with flow balancing and an advanced (probably custom) counterflow.

The following paragraphs describe some of inventive concepts disclosed herein.
(1) A method for chilling beverages that are brewed hot and then chilled rapidly, such as coffee and tea, wherein the heat is rejected using a compressor based heat pump including an evaporator, compressor, and condenser, wherein a heat exchanger is used to recover heat in order to pre-chill the coffee and pre-heat the source water.
(2) The method described in paragraph (1), wherein the heat exchanger water and coffee flows are parallel or counter, wherein the heat exchanger material configuration is a duct, tube in tube, tubes in shell, spiral, or stacked plate.
(3) The method described in paragraph (1) or paragraph (2), wherein depending on scale the compressor is a rotary, scroll, or centrifugal, the throttle is a capillary tube or expansion valve, and the condenser is forced air tube and fin or an industrial chiller in combination with a cooling tower.
(4) The method described in any of paragraphs (1) through (3), wherein the brew is via drip, immersion, or multi-stage immersion.
(5) The method described in any of paragraphs (1) through (4), wherein the brew is via drip using bypass water, wherein cold source water is used for bypass water, wherein the bypass water is introduced in the chill pot.
(6) The method described in any of paragraphs (1) through (5), wherein the brew is via drip using bypass water, wherein cold source water is used for bypass water, wherein the bypass water is introduced upstream of the counterflow in order to purge the coffee lines.
(7) The method described in any of paragraphs (1) through (6), wherein a water buffer tank is used to balance coffee and water flowrates over time in order to increase counterflow effectiveness.
(8) The method described in any of paragraphs (1) through (7), wherein extra source water is used to pre-chill the coffee farther, wherein the extra source water is introduced before the counterflow and rejected after the counterflow.
(9) The method described in any of paragraphs (1) through (8), wherein a secondary filter is used to remove suspended solids from the brewed coffee in order to stabilize flavor and improve clarity.
(10) The method described in paragraph (9), wherein the filter is located after the chiller after a secondary pump.
(11) The method described in paragraph (9), wherein the filter is located before the chiller in order to reduce manufacturing operations.
(12) The method described in any of paragraphs (1) through (11), wherein the evaporator is employed in a batch process including a chill pot, a coil in direct contact with the coffee, and an agitator.
(13) The method described in any of paragraphs (1) through (12), wherein the evaporator is employed in continuous process, in counter or parallel flow, wherein the heat exchanger material configuration is a duct, tube in tube, tubes in shell, spiral, or stacked plate.
(14) The method described in any of paragraphs (1) through (13), wherein the brew process is drip or multi-stage immersion, wherein the chill and brew time durations overlap in order to minimize cycle time.
(15) An apparatus configured to implement the method described in any of paragraphs (1) through (14).

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

1. An apparatus, comprising:
a heater configured to heat water to produce heated water;
a brewer configured to brew a beverage using the heated water;
a chiller configured to chill the beverage to produce a chilled beverage; and
a heat exchanger having a first fluid flow path and a second fluid flow path in thermal communication with the first fluid flow path, wherein:
an input to the first fluid flow path is configured to receive source water and an output of the first fluid flow path is configured to provide the water to the heater, and
an input to the second fluid flow path is configured to receive the beverage from the brewer and an output of the second fluid flow path is configured to provide the beverage to the chiller.

2. The apparatus of claim 1, further comprising:
a heat pump including an evaporator, a compressor, a condenser, and a throttle;
wherein the chiller is configured to transfer heat from the beverage to refrigerant in the evaporator.

3. The apparatus of claim 1, further comprising:
a bypass water feedline connected between a supply line for the source water and the input or the output of the second fluid flow path so as to allow introduction of bypass water into the beverage.

4. The apparatus of claim 3, wherein the bypass water feedline is connected to the input of the second fluid flow path.

5. The apparatus of claim 3, wherein the bypass water feedline is connected to the output of the second fluid flow path.

6. The apparatus of claim 1, further comprising:
a water reject line configured to divert a quantity of water from the output of the first fluid flow path away from the heater.

7. The apparatus of claim 1, further comprising:
a buffer tank configured to receive a quantity of water from the output of the first fluid flow path before the water is provided to the heater.

8. The apparatus of claim 1, further comprising:
at least one filter configured to filter the beverage to remove suspended solids therefrom.

9. The apparatus of claim 8, wherein the at least one filter comprises a first filter located in line between the output of the second fluid flow path and the chiller.

10. The apparatus of claim 8, wherein the at least one filter comprises a second filter located downstream of the chiller.

11. The apparatus of claim 10, further comprising a first pump located in line between the chiller and the second filter to pump the chilled beverage through the second filter.

12. The apparatus of claim 1, further comprising a second pump positioned in line between the brewer and the input of the second fluid flow path to pump the beverage through the second fluid flow path.

13. A method, comprising:
heating water with a heater to produce heated water;
brewing a beverage with a brewer using the heated water;
chilling the beverage with a chiller to produce a chilled beverage;
receiving source water at an input to a first fluid flow path of a heat exchanger and providing the water to the heater via an output of the first fluid flow path, the first fluid flow path being in thermal communication with a second fluid flow path of the heat exchanger; and
receiving the beverage at an input to the second fluid flow path and providing the beverage to the chiller via an output of the second fluid flow path.

14. The method of claim 13, wherein chilling the beverage comprises transferring heat from the beverage to refrigerant in an evaporator of a heat pump.

15. The method of claim 13, further comprising:
feeding bypass water from a source of the source water to the input of the second fluid flow path so as to introduce the bypass water into the beverage.

16. The method of claim 13, further comprising:
feeding bypass water from a source of the source water to the output of the second fluid flow path so as to introduce the bypass water into the beverage.

17. The method of claim 13, further comprising:
diverting a quantity of water from the output of the first fluid flow path away from the heater.

18. The method of claim 13, further comprising:
receive a quantity of water from the output of the first fluid flow path in a buffer tank before the water is provided to the heater.

19. The method of claim 13, further comprising:
filtering the beverage to remove suspended solids therefrom.

20. The method of claim 19, wherein filtering the beverage comprises filtering the beverage with a first filter located in line between the output of the second fluid flow path and the chiller.

21. The method of claim 19, wherein filtering the beverage comprises filtering the beverage with a second filter located downstream of the chiller.

22. The method of claim 21, further comprising pumping the chilled beverage through the second filter using a first pump located in line between the chiller and the second filter.

23. The method of claim 13, further comprising pumping the beverage through the second fluid flow path using a second pump positioned in line between the brewer and the input of the second fluid flow path.
